(19) United States
(12) Patent Application Publication
(10) Pub. No.: US 2019/0019134 A1
(43) Pub. Date: Jan. 17, 2019

(54) COMPUTERIZED WORK FROM HOME ORGANIZER SYSTEM

(71) Applicants: Earl Senchuk, Marquette, MI (US); Vincent B. Re, Brighton, MI (US)

(72) Inventors: Earl Senchuk, Marquette, MI (US); Vincent B. Re, Brighton, MI (US)

(21) Appl. No.: 16/033,026

(22) Filed: Jul. 11, 2018

Related U.S. Application Data
(60) Provisional application No. 62/531,308, filed on Jul. 11, 2017.

(51) Int. Cl. G06Q 10/06; G06Q 10/08

(52) U.S. Cl. CPC G06Q 10/063118; G06Q 10/0875; G06Q 10/06313

(57) ABSTRACT

A computerized system for operating a distributed manufacturing process includes a computerized server device. The server device operates programming configured to publish an available manufacturing project available for license, create a licensing contract between an entrepreneur owning a licensing right for the available manufacturing project and a project manager seeking the licensing right, create at least one contract between the project manager and a cell leader to manage work operation contracts necessary to perform the available manufacturing project, and create at least one contract between the cell leader and a cell member to perform a work operation necessary to perform the available manufacturing project.

### CROSS REFERENCE TO RELATED APPLICATIONS

This disclosure claims the benefit of U.S. Provisional Application No. 62/531,308 filed on Jul. 11, 2017 which are both hereby incorporated by reference.

### TECHNICAL FIELD

This disclosure is related to a computerized system for organizing a workflow, more specifically, for setting up a multi-location manufacturing chain operated by independent actors.

### BACKGROUND

The statements in this section merely provide background information related to the present disclosure. Accordingly, such statements are not intended to constitute an admission of prior art.

Items for sale are frequently made on an assembly line where a part is worked on by multiple persons, each person performing a step or a sequence of operations on the item, with the finished product being produced at an end of the assembly line. Modern logistics systems are known where a plurality of manufacturing facilities each make components to an assembly, and the components are brought together to be assembled at another facility. This system can be repeated over and over again to make complex items.

### SUMMARY

A computerized system for operating a distributed manufacturing process includes a computerized server device. The server device operates programming configured to publish an available manufacturing project available for license, create a licensing contract between an entrepreneur owning a licensing right for the available manufacturing project and a project manager seeking the licensing right, create at least one contract between the project manager and a cell leader to manage work operation contracts necessary to perform the available manufacturing project, and create at least one contract between the cell leader and a cell member to perform a work operation necessary to perform the available manufacturing project.

### BRIEF DESCRIPTION OF THE DRAWINGS

One or more embodiments will now be described, by way of example, with reference to the accompanying drawings, in which:

FIG. 1 illustrates operation of a computerized distributed manufacturing system, in accordance with the present disclosure.

FIG. 2 illustrates an exemplary process whereby a cell member or job seeker can bid upon a work operation contract, in accordance with the present disclosure.

FIGS. 3 and 4 illustrate an exemplary process whereby a cell leader can bid upon a contract to supervise a sub-project or portion of an overall project, in accordance with the present disclosure.

FIGS. 5 and 6 illustrate an exemplary process whereby a project leader can bid upon a project and manage operation of the project, wherein the project is a “pull” project filling an existing purchase order placed by a merchant, in accordance with the present disclosure.

FIGS. 7 and 8 illustrate an exemplary process whereby a project leader can bid upon a project and manage operation of the project, wherein the project is a “push” project filling to create a store of finished products for subsequent sale to underdetermined parties, in accordance with the present disclosure.

FIG. 9 illustrates an exemplary process whereby an entrepreneur can make a product available for license as a project, in accordance with the present disclosure.

FIG. 10 illustrates an exemplary computerized server device configured to operate the disclosed system, in accordance with the present disclosure.

### DETAILED DESCRIPTION

A system for organizing labor for a plurality of persons each working from their homes, with the work product of each person being ordered and directed by the system, is disclosed. According to one embodiment of the disclosure, the disclosed system can be described as a Home Operated Manufacturing Enterprise (H.O.M.E. system).

A product is selected for manufacture through members of the system. A discreet process to manufacture the product is identified, the process including a plurality of steps or work operations. Various production analysis methods can be utilized to formulate discreet work operations. The system provides available work operations to a plurality of candidate workers. The candidate workers can look over available work operations and select a work operation to fulfill. In one embodiment, work operations can include auxiliary tasks such as sales and marketing. The work operation may include raw materials or work product from a prior work operation that need to be used to complete the work product for the work operation to be completed, with these materials being shipped to the home of the worker for assembly. In another example, specifications for the work may be provided, and the worker may be given a purchase order or may be responsible for purchasing conforming raw materials. Each worker can operate as an individual business. A blueprint or work product instruction sheet can be provided by the system to the worker, including critical characteristics that the work product must conform to be accepted and paid for by the system or the next worker in the production chain. Training for particular roles or skills can be provided or advertised. At the end of the production chain, the product can be shipped back to the person that entered the requirement or a last person in the chain may take the role as a salesperson. In one embodiment, each member can be a salesperson receiving credit and/or commission for each sale.

Reimbursement through the system can come in a number of ways. Work in a project can be hourly, with the task being assigned an allotted time value (e.g., make 500 of these bracelets for 8.0 hours of pay.) Pay can be by the piece produced or determined according to time work study analysis. In another embodiment, the prices of the work products of each work operation can be priced, and each person in the chain gets a proportional share of the margin for the final item being manufactured.

In one embodiment, one person can “own” the computerized process, and the system may generate emails or other communications with instructions to persons hired by the one person. Instructions can include work instructions, shipping labels (e.g., enabling one to drop off the finished product at a Fedex® site or similar location), and automatic payment for completion of work. In one embodiment, shipping or delivery can be a work operation for compensation or pay. In another embodiment, each person in the chain can operate or subscribe to the computerized system, with available products, available work operations, available products to be sold, etc. being available in a marketplace within the software.

In one embodiment, the software serves a group of members and the membership is responsible for managing roles and new members.

In another embodiment, the membership is open to any who would buy the software. The software can be sold as a unit, with every user paying a same price to buy or subscribe to the software. In another embodiment, users may select from a tiered system, for example, with one level of user being able to select products for manufacture at a high price, with another level of user being able to purchase work products in the production chain and deliver products to other users in the chain at a middle price, and with hourly workers having access to work operation postings at a low price or for free. These examples are intended as non-limiting examples of how the system may be structured and paid for.

A wide variety of services can be enabled by the computerized system. For example, a marketplace of patented inventions can be provided within the system, where patent owners can be invited to post their inventions with a listed royalty for use of the invention. A computerized process similar to the process on Shark Tank® can be operated, where the user is challenged to provide details, projections, marketability information, profit expectations etc. before the system will recommend that the process be undertaken. In another embodiment, the operators/administrators of the H.O.M.E system can provided skilled experts to perform systematic presentations of market potential for potential work projects. Work operations can be classified based upon skills (sewing, welding, high school degree, etc.) Prices for work operations can be automatically adjusted based upon whether work operations are quickly accepted or languish waiting for someone to accept them. A person may be able to select multiple operations in a single chain, for example, taking operations 1-3 out of a total of 5 work operations in the task, that person then getting the shipping costs that would otherwise have been incurred as extra profit. Tasks, orders, available products, etc. can be provided to retailers, for example, with a Walmart® being able to put in a purchase order for 10,000 of a product, which will automatically initiate corresponding work operations postings to fulfill the order.

Benefits of the home organizer are many. For example, persons can choose as much or as little work from home, thereby enabling that person to make money and take care of home obligations (children, elderly relatives, etc.) Work operations can include flexible parameters, such as posting offering $10 per hour if the worker needs a sewing machine supplied or $20 per hour if the worker has a sewing machine. Monetary values of work operations can include shipping costs, for example, enabling persons living in close proximity to maximize profits by working together. In another embodiment, shipping can be posted as a work operation, enabling one to make money running shipments around a particular area, with a professional carrier order following if no one accepts the work operation posting by a certain time. The work operations can be selected a la carte, enabling one, for example, to personally order a production run, personally execute the work operations in the beginning of the chain, ensuring that a desired set of raw materials are used to start the project, permit other to accept work operations postings for all of the other tasks to create the items in the production run, and then execute the last work operation to have the finished product delivered to that person for sale or picked up by a purchaser at the designated location within a cell. A number of exemplary benefits of the disclosed system are envisioned, and the examples of the disclosure are not meant to be limiting.

According to one embodiment, the H.O.M.E. system can provide analysis useful to determine product interest relative to particular locations (e.g. maps can be generated where a particular product could be most well received based upon demographics, sales of similar products, weather patterns, etc.)

The H.O.M.E. manufacturing system can be equally about a company profiting by the selling of products as it is driven by the creation of self employment. The products are special in that most do not fit the model of normal marketing avenues. Manufacturing such products in a factory under normal circumstances would result in low profit and high risk for knockoff. In almost all respects, the H.O.M.E. System employs a uniquely different approach to marketing.

The H.O.M.E. System creates an environment whereby ordinary people can connect their skills and ideas so as to enjoy a larger share in the profit that can come from manufacturing and selling products while working out of their homes, shops, or barns.

The intent of the H.O.M.E. System is to overcome the ever present threat of knockoffs and get around the high cost and confusion people have about patents.

According to one embodiment, five basic components make up the H.O.M.E. System.

One, the organizer/facilitator, (a.k.a. H.O.M.E. adminstrator); two, the zone leader (or project manager); three, the cell leader; four, the cell member (or job seeker), and five, the inventor (or entrepreneur.)

The organizer/facilitator (a.k.a. H.O.M.E) can coordinate purchasing and distribution of raw materials, training of personnel, distribution and sales outside the cell zones, make payroll to all parties, determines the MSRP (Manufacturer's Suggested Retail Price), and set up an environment for creative thought toward the development of new products and production methods.

The zone leader can conduct a supervisory role within a zone. Zones are large territories comprising multiple cells. A cell is a base of independent operation. According to one embodiment, the zone leader is elected by the cell members within that zone.

The cell leader can maintain storage and dispensation of raw materials and finished goods locally, track inventory, and can also manufacture and sell.

The cell member can pay a one time initiation fee to become a member. The fee gives the member entitlement for training and rights to manufacture and sell as well as engagement in decisions regarding sales of H.O.M.E. system products.

The inventor (who can additionally serve as any cell member) introduces new products for possible manufacture and sale through the system in exchange for royalty compensation.

In a normal market setting, high price points can be driven by manufacturing costs, including factors like product size, mold costs, odd shape, shipping, weight, fixed profit margins, all of which make them less desirable to mass merchandisers who measure shelf space as profit per square foot. This leaves open an entirely untapped market for hundreds of useful and desirable products that could be manufactured and sold locally.

The products can require simple tools to make and can be graded to be within the means to manufacture component parts in a person's home space. The components are varied and as such, require different areas of expertise thereby creating self employment amongst a range of capabilities (sewing, welding, cutting, assembly, drilling, delivery, installation, etc)

H.O.M.E. System pricing does not require a strict bottom-line margin of profit like that necessary to support all the levels under corporate management which includes the CEO, administration, labor, and factory overhead.

Because the system operates without a factory, that amount of overhead per product can be shifted to others along with a number of other marketing mainstays of operation. Manufacturer's reps can be employed (5-10% commission on wholesale and/or retail sales). Rather than paying one person who simply has an inside track to a big box buyer, it can be spread out so that everyone can get a piece of every individual sale they make. Every sale drives more employment. The products are not intended for sales through mass merchandisers (who demand a 60-100% margin of profit), but the sale price can still be the same. There are no accessorial negotiations (e.g. 2%-10, net 30; early order, early delivery, warehousing; shipping, etc.) By diverting these added costs, a greater share in the profits can be realized by H.O.M.E. System members for accomplishing the same end result, a manufactured product for sale.

According to one embodiment, the Manufacturer's Suggested Retail Price (MSRP) is established by H.O.M.E. However, cell members are independent business persons and are free to work their own deals on products they purchase for resale.

Promotion of the H.O.M.E. system can be largely conducted by the cell members with assistance by H.O.M.E. thru press releases, donations of product to worthy causes, trade and consumer shows, television, social media, word-of-mouth, the H.O.M.E. system website, and roadside display. No paid advertising is anticipated. Wholesale/retail Sales outside the Cell zones are accomplished by normal marketing methods by H.O.M.E.

Since cell members can easily out-produce what they can sell locally, the excess becomes available to H.O.M.E for sales outside the cell zones on a normal wholesale/retail basis. For the system to work, H.O.M.E must be able to find outlets to wholesale/retail sales on at least some products. New cell zones are established only if sales exceed capability to manufacture. As sales within a zone reach a point of saturation, new products are being developed for manufacture

H.O.M.E can sell anywhere outside any cell zone in any manner it sees fit including trade and consumer shows, farmer's markets, gas stations, street corners, mass merchandisers, mom and pop stores, etc.

Cell members can be paid a sales commission for selling a finished product at the MSRP within or outside a Cell Zone without ever having to see or touch the product. Every sale generates more work for members.

Members can purchase a product outright from H.O.M.E., or trade the value of earned income and use that money to buy products at a privileged level below wholesale price either for personal use or for resale at a profit.

Depending on the type of product, cell members can purchase a product outright, or trade labor for finished product and use that product to generate income secondarily by growing plant starts, selling compost, growing produce, etc. Cell members can submit a product invention deemed marketable by other members in exchange for a royalty. No patent is required, but the product must be free from infringement. Cell members can earn bonuses for ideas that cut costs to manufacture.

Cell members can sell to individuals only, not to mass merchandisers, retail outlets, or catalog companies (unless the members own the retail outlet, a.k.a. a mom and pop store.)

To purchase any product online through the H.O.M.E. System website requires log in credentials. This is necessary to determine where and to whom commissions are to be paid. If an online purchase is made and no member is identified to receive a commission, the amount of that commission goes to a worthy cause chosen by the purchaser from a list of causes, or to H.O.M.E if no cause is selected. The list of causes is subject to change.

For cell members to be considered independent business persons, they must use their own tools and purchase the raw materials with which to make a component part of a product. The materials purchase amount, less H.O.M.E's cost for handling and minimal markup, is reimbursed to the cell member upon finished inspection of the component.

Cell members are responsible for their own taxes and are paid on a Form 1099 basis. Commissions for sales are paid subsequent to delivery and installation. To engage in sales, the cell member must have acquired a sales tax license posted to H.O.M.E. No sales commission is paid for products purchased by a cell member for resale.

An exemplary 5% royalty based on wholesale and retail sales of the inventor's product(s) sold by H.O.M.E. as well as gross sales by any and all cell members selling for commission.

Any and all of the positions available through the disclosed system can include ratings, wherein at the completion of the project, each participant can rate the involvement of the other participants. Cell members can be rated for the quality and timeliness of their work. Cell leaders can be rated for reasonableness and clarity of instruction. Project managers can be rated for successfulness of previous projects, pay levels throughout their projects, and clarity of instructions throughout their projects.

Work operation contracts can include shipping instructions for the parts in process to move from one home to the next. In addition or in the alternative, work operation contracts can include requirements that a worker come to a particular location, for example, to reduce costs for large objects. One exemplary work operation can be posted offering payment for a welding expert to come to a particular location and complete final assembly of boat trailer parts within a two week window for a particular payout as opposed to the trailer parts being shipped to the welder. In this way, the overall efficiency of a cell or project can be improved.

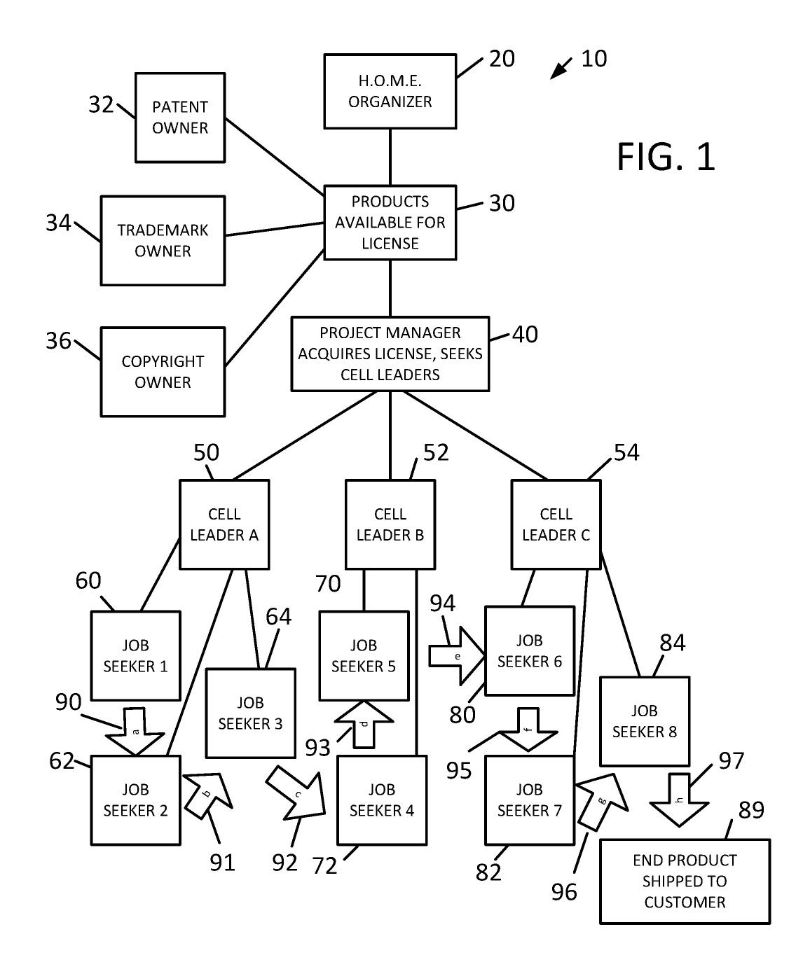

Referring now to the drawings, wherein the showings are for the purpose of illustrating certain exemplary embodiments only and not for the purpose of limiting the same, FIG. 1 illustrates an exemplary computerized distributed manufacturing system in operation, with the system enabling a home organizer to choose between a number of available inventions, access licensing information for access to the inventions, and then being able to create orders for work products necessary to complete a batch of products related to a selected invention. The distributed manufacturing system 10 is illustrated, including the H.O.M.E. organizer 20 providing structure to system, providing a computerized application for the various involved parties to log into, providing storage and computerized access to the various available projects, bills of material, part prints, and other associated resources required to make the system work. Product available for license 30 are provided, based upon entries from various entrepreneur groups, including but not limited to patent owners 32, trademark owners 34, and copyright owners 36. Among these creative people, projects are provided and vetted and then listed as available for project managers to bid upon. In another example, a company can provide projects available for bid (for example, an automotive supplier can create a project for bid to assemble 1,000 sun visors, where the supplier will send all of the parts and the project includes assembly of the visor components, sewing of the fabric, testing of rotation of the connecting arm and testing of the lighted mirror.) Project managers review the available projects online and can a acquire license and seek cell leaders 40 to execute the license and build the product or products covered by the license. Cell leaders 50, 52, and 54 are contracted, whom in turn contract with job seekers 60, 62, 64 (working under “cell leader A” 50); seekers 60, 62, 64 (working under “cell leader B” 52); and seekers 80, 82, 84 (working under “cell leader C” 54.) The job seekers, otherwise known or termed as cell members, produce the product that is the subject of the license acquired by the project leader through product flow 90, 91, 92, 93, 94, 95, and 96, until the finished product is shipped through flow 97 as end product shipped to customer 89. System 10 is provided as exemplary, the examples provided are intended to be non-limiting, and a number of variations to the various portions of the system are envisioned.

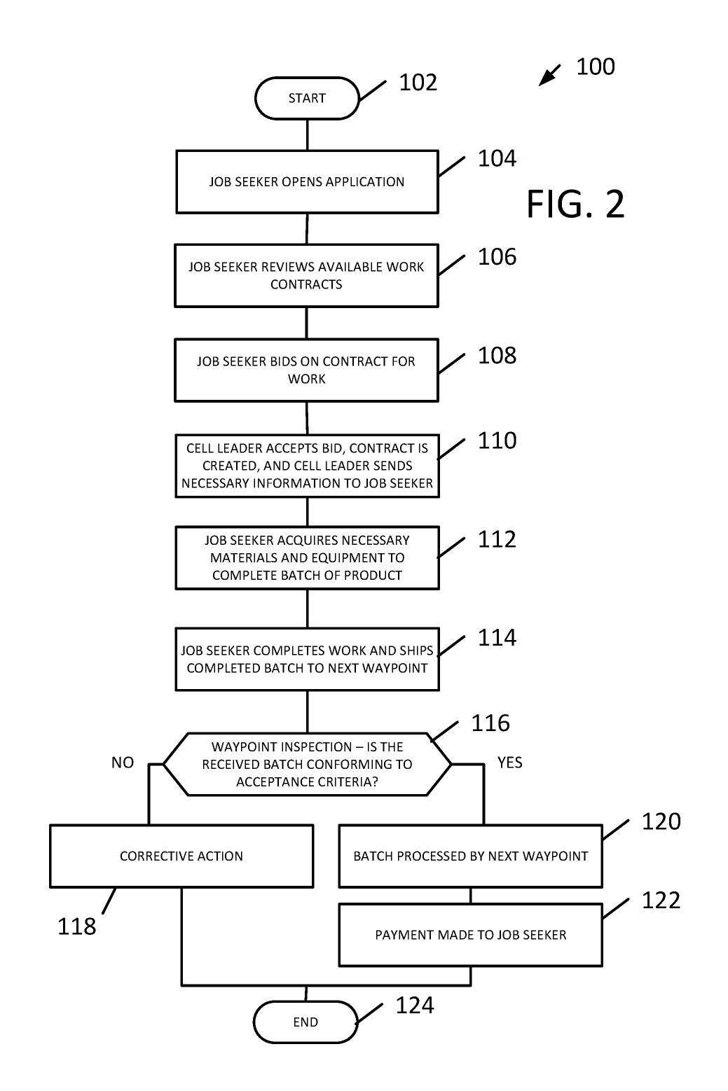

FIG. 2 illustrates an exemplary process whereby a cell member or job seeker can bid upon a work operation contract. Process 100 is illustrated including step 102 where the process starts. At step 104, a job seeker, having purchased or gotten access to the H.O.M.E. system, opens the computerized application. At step 106, the job seeker reviews available work operations that are available for bid. The work operations can be open, meaning that no special skill set is required to bid upon the jobs. Other work operations available for bid can require special training (for example, as can be provided through the H.O.M.E. system), special degrees or education (for example, a CNC machinist certificate), special work experience (for example, 3 years of welding experience required), or access to special equipment (for example, access to a sewing machine required.) At step 108, the job seeker bids on a contract for a particular work operation. At step 110, the cell leader responsible for the work operation posting accepts the bid, and the cell leader sends to the job seeker all of the required information to perform the work operation. At step 112, the job seeker acquires the necessary materials and equipment to complete the required batch of the product detailed in the work operation. At step 114, the job seeker completes the work operation and ships the completed batch to the next waypoint, frequently to another job seeker working for the cell leader. At step 116, an inspection is made of the batch shipped by the job seeker, and a determination is made whether the batch conforms to acceptance criteria for the product of the batch. If the batch is not confirming, at step 118 corrective action is taken. A number of corrective actions can include but are not limited to the batch being returned to the job seeker for rework, the batch being sent to the cell leader for inspection, and the batch being rejected and the cell leader posting a prioritized contract for bid to replace the batch. If the batch is conforming, then at step 120 the batch is processed by the next waypoint. At step 122, payment is made to the job seeker for successfully filling the work operation of the contract. At step 124 the process ends. Process 100 is provided as exemplary, the examples provided are intended to be non-limiting, and a number of variations to the various portions of the process are envisioned.

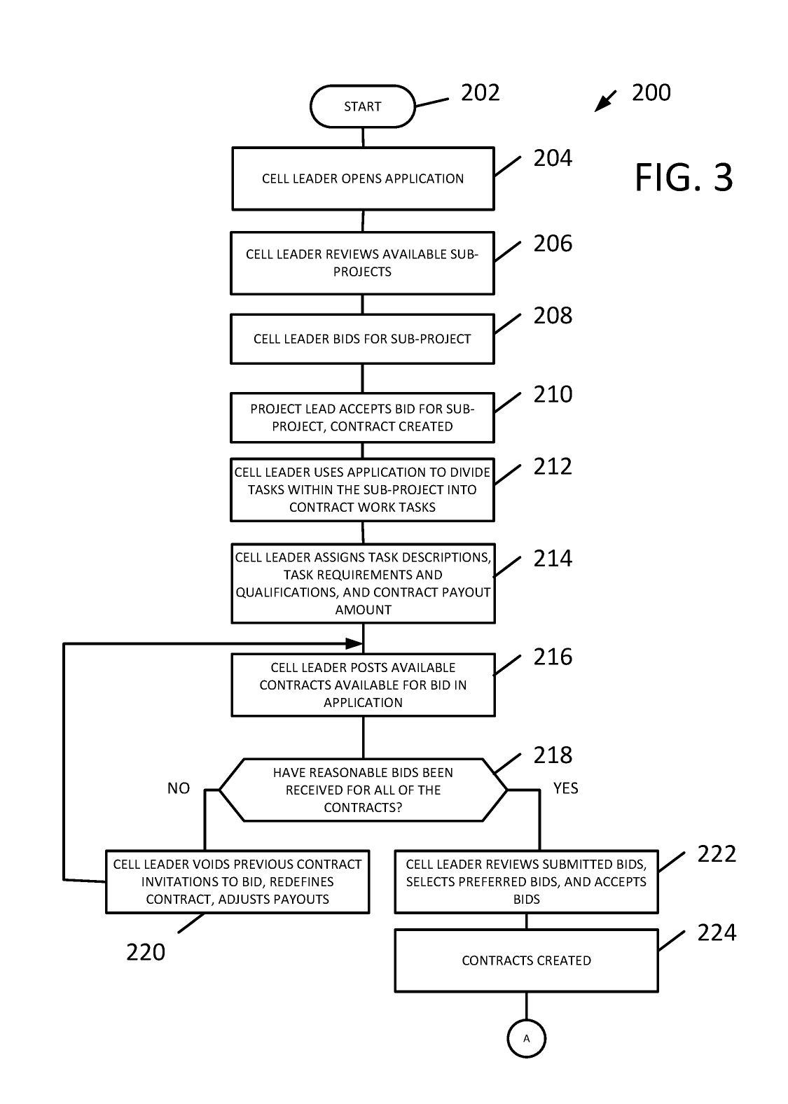

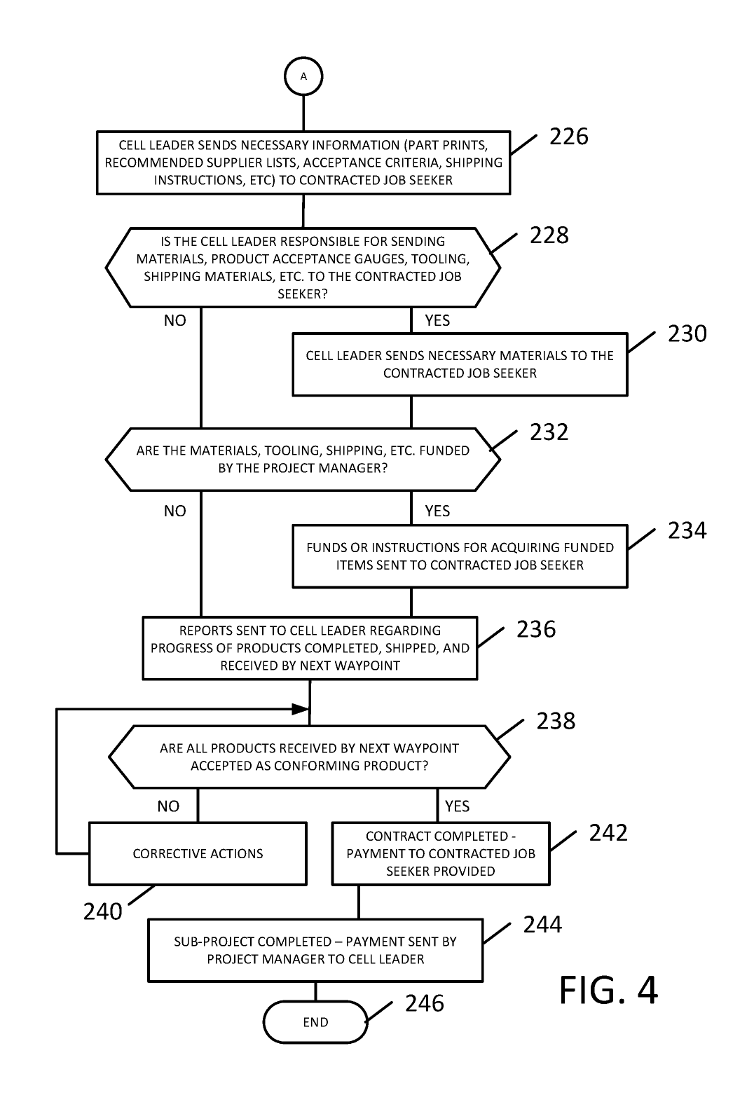

FIGS. 3 and 4 illustrate an exemplary process whereby a cell leader can bid upon a contract to supervise a sub-project or portion of an overall project. Process 200 starts at step 202. At step 204, the cell leader opens the H.O.M.E. system application. At step 206, the cell leader reviews available sub-projects available for bidding. The sub-projects can be open, meaning that no special skill set is required to bid upon the cell leader positions. In other examples, particular experience or training might be required, for example, requiring 5 years minimum hourly supervision, completion of a “quality and logistics” course provided by the system organizers, or a certain minimum rating for previous projects. At step 208, the cell leader submits a bid for a sub-project. At step 210, the project leader or project manager accepts the bid for the sub-project and a contract is created between the project leader and the cell leader. At step 212, the cell leader is provided with details about the work that must be done within her or his cell, and the cell leader uses an optional tool within the H.O.M.E. software to divide and detail the various work operations that are required to fulfill all of the work for the cell. At step 214, the cell leader assigns task descriptions, task requirements and qualifications, and contract payout amounts for each work operation to be posted. At step 216, the cell leader posts available contracts which can be bid upon by job seekers. At step 218, a determination is made whether reasonable bids have been received for all contracts posted for the cell. If reasonable bids have not been received, at step 220, the cell leader can void previous contract invitations, redefine contract terms, adjust payout amounts, and repost the contracts at step 216. In this way, cell leaders can be flexible and use experience within the system to fill the necessary work operations required for the cell to complete the required work. If reasonable bids have been received, the cell leader at step 222 reviews the bids, selects preferred bids, and accepts the preferred bids. At step 224, contracts are created between the cell leader and the job seekers. At step 226, the cell leader sends the necessary information for each work operation to each of the job seekers. At step 228, if the cell leader is responsible for sending any of materials, product acceptance gauges, tooling, shipping materials or other similar objects to the contracted job seekers, the process advances to step 230 where the required objects are sent. If no objects are required to be sent at step 228, the process advances to step 232. At step 232, if the cell leader is responsible for providing funding to the contracted job seekers for materials, tooling, shipping, etc., the process advances to step 234 and the funding is provided. If funding is not to be provided by the cell leader, the process advances to step 236, where reports are sent to the cell leader regarding progress of the various contracted job seekers, progress of product batches shipped and received, and the completion status of the various work operations. At step 238, a determination is made whether all products required to be completed by the cell are accepted as conforming products. If they are not conforming, at step 240, corrective actions are taken. A number of corrective actions can include but are not limited to the batch being returned to one of the contracted job seekers for rework, the batch being sent to the cell leader for inspection, and the batch being rejected and the cell leader posting a prioritized contract for bid to replace the batch. If the products produced by the cell are confirmed to be conforming, at step 242, the contract for the sub-project is completed and payment to the job seekers of the cell is authorized. At step 244, the sub-project being completed, the project leader pays the cell leader according to the contract. At step 246, the process ends. Process 200 is provided as exemplary, the examples provided are intended to be non-limiting, and a number of variations to the various portions of the process are envisioned.

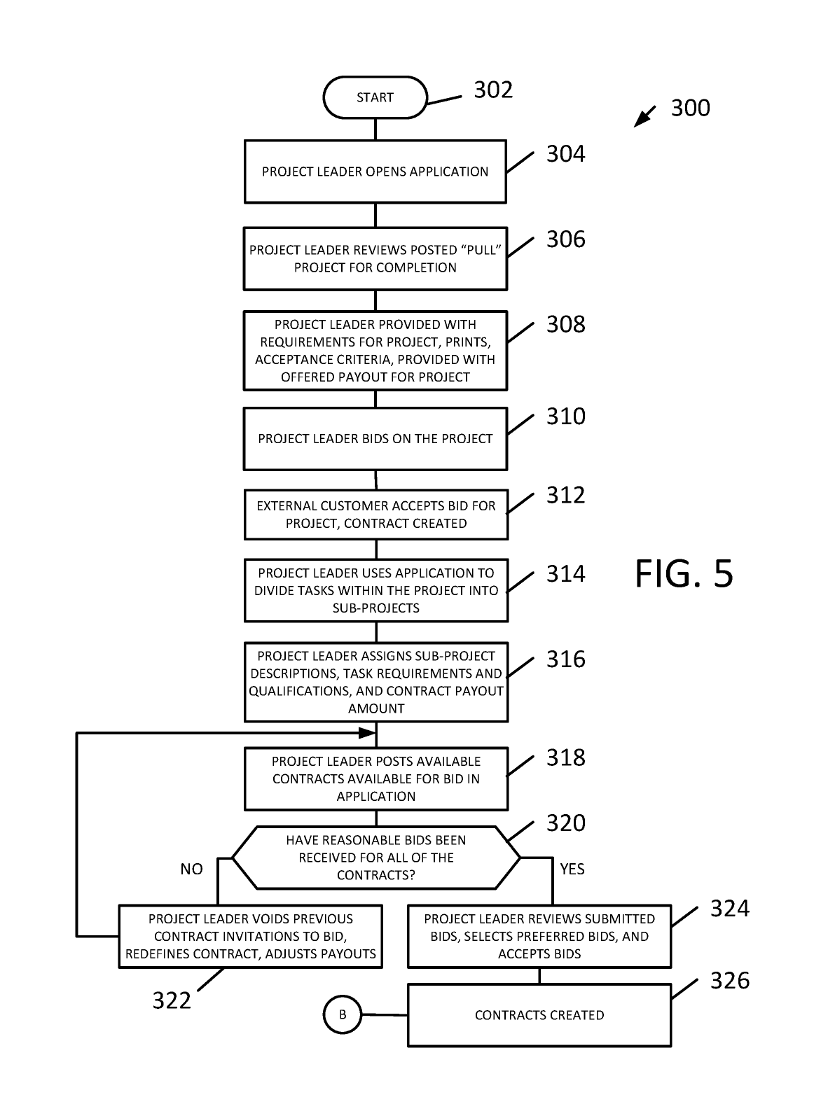

Entrepreneurial project leaders can review available projects, perform marketing studies, and determine which projects are likely to be commercial successes. The project leaders can fund projects based upon an intention to sell the products to yet underdetermined vendors. In another example, a group of people can band together, select a project, select among themselves cell leaders and/or a project manager, hire missing resources, and choose to collectively complete a project. Either a top down, project manager controlled, or bottom up, collective operation by a group, projects can be initiated. FIGS. 5-8 illustrate exemplary top down versions of the project manager roles. One will appreciate that with minor changes, the project manager roles and decisions can be assumed by a group and delegated in part to an elected or hired project manager by the group.

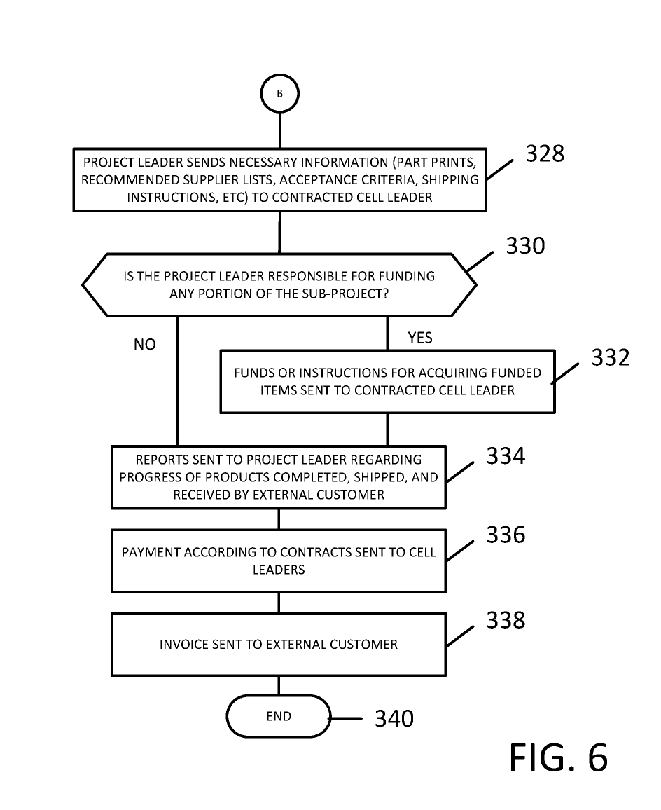

FIGS. 5 and 6 illustrate an exemplary process whereby a project leader can bid upon a project and manage operation of the project, wherein the project is a “pull” project filling an existing purchase order placed by a merchant. The disclosed system can advertise or list products that can be batch ordered by merchants. If a merchant places an exemplary order for 1,000 of a product, a pull project for the order is listed as a project contract available for bid. Process 300 starts at step 302. At step 304, the project leader or project manager opens the application. At step 306, the project leader reviews a posted “pull” project for available for completion. At step 308, the project leader is provided with all available details for the available project being reviewed, such that the project leader can vet what resources are needed for the project, what special skills are required, whether the project will be profitable, etc. At step 310, the project leader bids on the project. At step 312, the external customer accepts the bid for the project and a contract is created between the external customer and the project leader. At step 314 the project leader can use an optional tool within the H.O.M.E. software to divide and detail the various portions of the overall project between cells to be created as sub-projects. At step 316, the project leader assigns sub-project descriptions, task requirements and qualifications, contract payout amounts, etc., for each of the sub-projects to be posted. At step 318, the project leader posts available contracts as available for bid in the system application. At step 320, a determination is made whether reasonable bids have been received for all contracts. If not, at step 322, the project leader can void previous contract invitations for bid, can redefine the contract terms including adjusting payout amounts, and at step 318 the adjusted contracts can be re-posted. If reasonable bids have been received from potential cell leaders, the process advances to step 324 where the project leader reviews the submitted bids, selects preferred bids, and accepts the preferred bids. At step 326, contracts are created between the project leader and the cell leaders. At step 328, the project leader sends the necessary information to all of the contracted cell leaders. At step 330, if the project leader is responsible for funding any portions of a sub-project, the process advances to step 332 where the funding is provided. If funding is not required, the process advances to step 334 where reports are sent to the project leader regarding completion of the required products, products shipped to and received by the external customer. At step 336, the project leader pays the cell leaders according to the contracts. At step 338, an invoice for payment is sent to the external customer for the completed project. At step 340, the process ends. Process 300 is provided as exemplary, the examples provided are intended to be non-limiting, and a number of variations to the various portions of the process are envisioned.

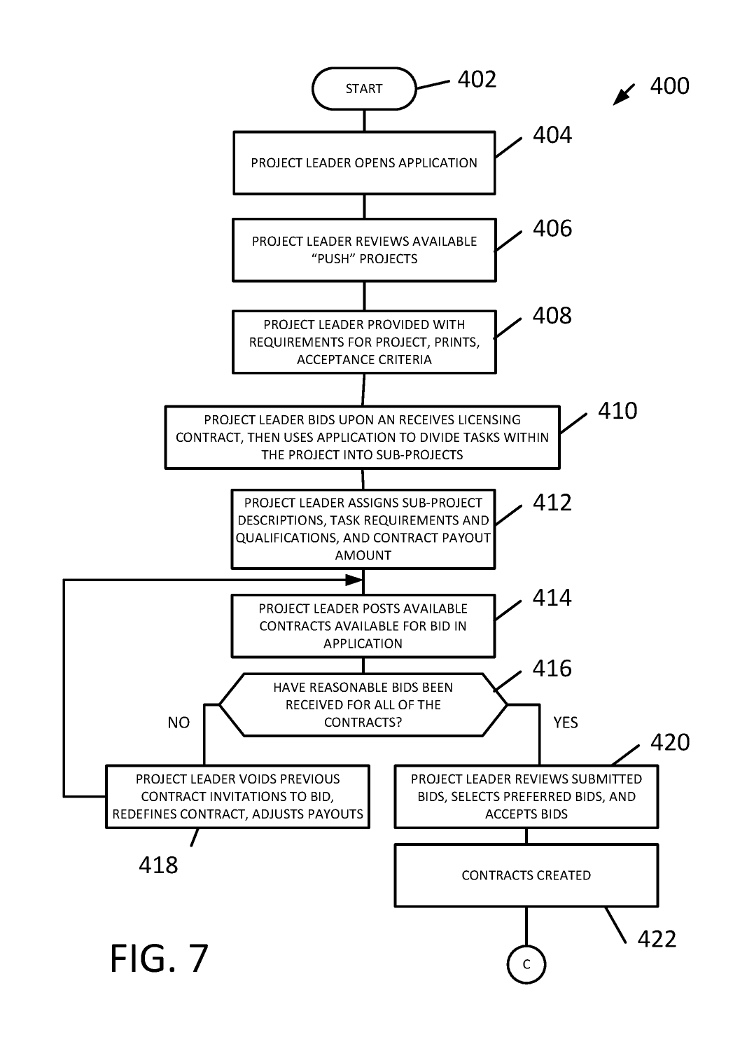

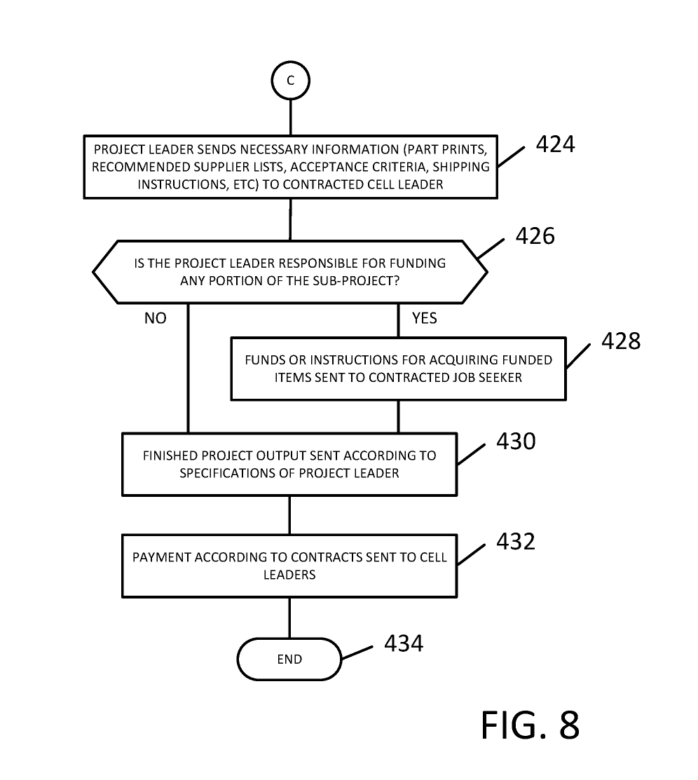

FIGS. 7 and 8 illustrate an exemplary process whereby a project leader can bid upon a project and manage operation of the project, wherein the project is a “push” project filling to create a store of finished products for subsequent sale to underdetermined parties. Entrepreneurial project leaders can review available projects, perform marketing studies, and determine which projects are likely to be commercial successes and create a push project. Process 400 starts at step 402. At step 404, the project leader or project manager opens the application. At step 406, the project leader reviews posted “push” projects for available for completion. At step 408, the project leader is provided with all available details for the available project being reviewed, such that the project leader can vet what resources are needed for the project, what special skills are required, whether the project will be profitable, etc. At step 410, the project leader bids on the project, receives the licensing contract for the project, and proceeds to divide the necessary tasks within the project into sub-projects available for bid. At step 412, the project leader assigns sub-project descriptions, task requirements and qualifications, contract payout amounts, etc., for each of the sub-projects to be posted. At step 414, the project leader posts available contracts as available for bid in the system application. At step 416, a determination is made whether reasonable bids have been received for all contracts. If not, at step 418, the project leader can void previous contract invitations for bid, can redefine the contract terms including adjusting payout amounts, and at step 414 the adjusted contracts can be re-posted. If reasonable bids have been received from potential cell leaders, the process advances to step 420 where the project leader reviews the submitted bids, selects preferred bids, and accepts the preferred bids. At step 422, contracts are created between the project leader and the cell leaders. At step 424, the project leader sends the necessary information to all of the contracted cell leaders. At step 426, if the project leader is responsible for funding any portions of a sub-project, the process advances to step 428 where the funding is provided. If funding is not required, the process advances to step 430 where the finished project output is sent according to the specifications of the project leader, for example, to a warehouse or to merchants that the project leader has made arrangements with. At step 432, the project leader pays the cell leaders according to the contracts. At step 434, the process ends. Process 400 is provided as exemplary, the examples provided are intended to be non-limiting, and a number of variations to the various portions of the process are envisioned.

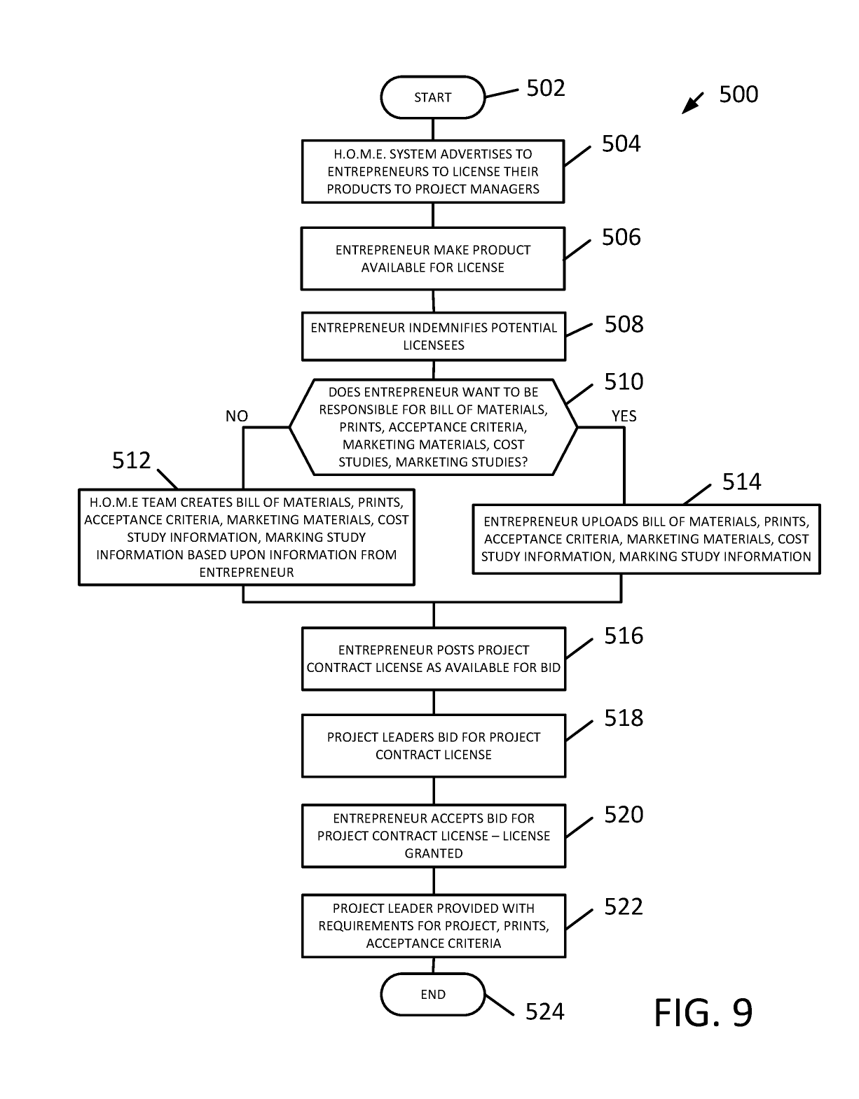

FIG. 9 illustrates an exemplary process whereby an entrepreneur can make a product available for license as a project. Process 500 starts at step 502. At step 504, the H.O.M.E system advertises, for example, through an online portal, to entrepreneurs and intellectual property owners an ability to license their inventions, creative works, trademarked products, etc. to project leaders or managers for manufacture. At step 506, the entrepreneur follows required vetting steps and agrees to make the product available for license. At step 508, an optional step can be required where the entrepreneur is required to indemnify licensees against infringement suits, product liability concerns, and other legal issues. In one example, such a step can include referrals to insurance companies providing guidance and coverage against such indemnification. As a sub-requirement or feature, the system can include a requirement that the entrepreneur upload results of a clearance or freedom to operate patent search as is known in the art for review by potential licensees. At step 510, a determination is made whether the entrepreneur seeking to license their product to licensees wants to create all of the necessary paperwork that a project manager will require to complete the project. In one embodiment, the system can provide or link to assets useful to creating the paperwork. For example, a CAD program can be provided to enable the entrepreneur to make prints. A spreadsheet can be provided to enable entry of a bill of materials. Software can be provided to enable the entrepreneur to designate UPC codes for a particular bolt or bracket that might be commercially available for order. If the entrepreneur does want to complete the necessary paperwork, the paperwork is uploaded into the system at step 514. If the entrepreneur does not want to complete the required paperwork, the entrepreneur at step 516 can hire assets within or outside of the disclosed system to create the necessary paperwork. In another example, the entrepreneur can be permitted to provide more limited details of the product, and generation of the potentially costly paperwork can be made terms of a licensing deal. At step 516 the entrepreneur posts the project contract license as available for bid. Such an offer for bid can include an open invitation for bids with the potential licensee being free to offer terms. In another example, the offer for bid can include specific requirements such as a 3% royalty requirement. At step 518, project leaders submit bids for the project contract license. At step 520, the entrepreneur accepts one of the bids and a license is granted through a contract. At step 522, the project leader is provided with any required information. At step 524, the process ends. Process 500 is provided as exemplary, the examples provided are intended to be non-limiting, and a number of variations to the various portions of the process are envisioned.

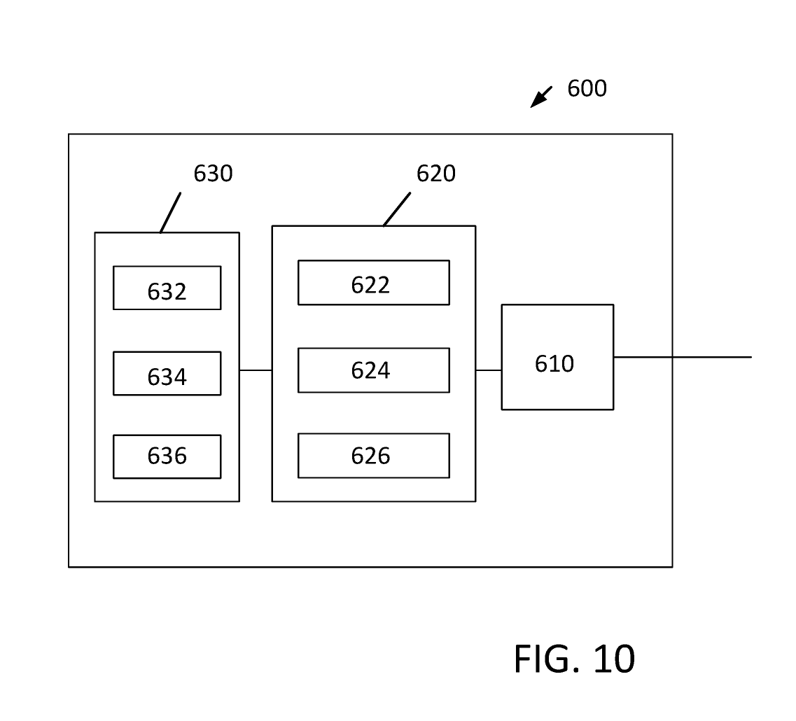

FIG. 10 illustrates an exemplary computerized server device configured to operate the disclosed system. Computerized remote server device 600 is illustrated, including processor device 620, durable memory storage device 630, and communication device 6100.

Processor device 620 includes a computing device known in the art useful for operating programmed code. Device 620 includes RAM memory and can access stored data through connection to memory storage device 630. Memory storage device 630 includes any hard drive, flash drive, or other similar device capable of receiving, storing, and providing access to digital data. Memory storage device can include libraries of information related to various license, cell, and work operation contracts available for bid; contracts created; contracts completed; product details; user details; customer details; payment service details; shipping information; and all other similar information necessary for operation of the disclosed system. In particular, storage device 630 includes product library 632 including details, bills of material, prints, etc. for various parts that are available for license; contract library 634 providing resources related to contracts available for bid and contracts actively operating; and user library 636 providing stored data about the various entrepreneurs, companies, project leaders, cell leaders, job seekers, and customers that have access to the disclosed system.

Processor device 620 includes programming modules which are provided as illustrated examples of how programmed code can be executed within a processor. Any number of modules, programs, applications, or third party services could be utilized equivalently with the illustrated programming modules. Project creation module 622, project support module 624, and contract execution modules 626 represent programmed functions that are exemplary of processes that can be carried out within processor device 620, but are intended to be non-limiting examples of such processes. Project creation module includes programming configured to coordinate the acceptance of products into the system, coordinate posting contracts for bid, and providing tools to the various users for the creation and definitions of projects, sub-projects, and work operations as disclosed herein. Project support module 624 includes programming to facilitate sending materials, funding, information, etc. to various cell leaders and cell members, coordinating all of the information and shipping requirements for completion of the work operations. Contract execution module 626 tracks acceptance of parts at various waypoints, completion of work operation and cell tasks, and generation or prompting of payment to the various involved parties.

Communication device 610 includes any wired or wireless communication system required to send and receive data from the computerized server device.

A similar computerized device such as a personal computer, a smart-phone, a computerized tablet, or other similar device can be used by project leaders, cell leaders, cell members, entrepreneurs, and customers to interface with the disclosed server device and provide the necessary information and interaction.

In some exemplary embodiments, a contract with any of the described parties can include a contract right to sell some portion of the products created. For example, a project manager can make contracts with cell leaders, enabling the cell leaders to sell up to 10% of the project output for commission or enabling the cell leaders to contract some of the sales rights to cell members.

The disclosure describes the formation of contracts between parties. In some instances, the disclosed system can accomplish formation of the contract between the parties, either accepting electronic signatures or requiring wet signatures to be uploaded as formal recognition of executed contracts, either where permitted by law. In other instances, such as where required by law, the system can accommodate external execution of the contracts, for example, providing paperwork to legal counsels and providing for recorded documentation of the externally executed documents once completed through legal counsel. Creating a contract between parties, as disclosed herein, can include portions of the process, such as publishing offers for bid, receiving and forwarding offers and counteroffers between the various parties.

A cell leader can post work operation tasks as available for bid according to the disclosed system. If no one places a reasonable bid on the work operation, the cell leader can redefine the work operations of the cell and/or change the pay associated with the work operation. In another embodiment, the cell leader can designate the work operation as undesirable and instead post the work operation to an outside venue seeking fulfillment of the work operation, for example, posting the work operation as work for hire in a trade journal or contacting a manufacturing shop or service to perform the undesirable work operation.

The disclosed system accepts products that include inventions, trademarks, or copyrights and provides for generating a contract to produce these products. In an exemplary embodiment, members of the system can identify a need for a product and post a desire for that product. For example, the system can provide a list of “please invent the following” entries. Once an inventor solves the stated problem, the resulting product or fix can be provided as a product available for licensing. Bids for contracts can include prices set by the person posting the offer to accept bids. In another embodiment, prices can be set within a range by the person posting the offer to accept bids, and the person making the bid can select a bid price for the other party to accept or decline. It will be appreciated that a cell member can be a person or a small shop with more than one employee could act as a cell member.

Work operations can be instructed or parameters for successful completion of work operations can be provided in a number of ways. Written requirements can be provided. Videos showing successful completion of the work operation can be provided. Animated work operation steps can be provided through a webpage or other similar service. Any number of methods to instruct work operations can be envisioned, and the disclosure is not intended to be limited to the particular embodiments provided herein.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A computerized system for operating a distributed manufacturing process, comprising:
a computerized server device, operating programming configured to:
publish an available manufacturing project available for license;
create a licensing contract between an entrepreneur owning a licensing right for the available manufacturing project and a project manager seeking the licensing right;
create at least one contract between the project manager and a cell leader to manage work operation contracts necessary to perform the available manufacturing project; and
create at least one contract between the cell leader and a cell member to perform a work operation necessary to perform the available manufacturing project.

2. The system of claim 1, wherein the computerized server device further operates programming configured to provide the project manager with details necessary to perform the available manufacturing project.

3. The system of claim 2, wherein providing to the project manager with details comprises providing the project manager with a bill of materials, prints, and acceptance criteria necessary to perform the available manufacturing project.

4. The system of claim 1, wherein the computerized server device further operates programming configured to create contracts between the project manager and a plurality of cell leaders to manage work operation contracts necessary to perform the available manufacturing project.

5. The system of claim 4, wherein the computerized server device further operates programming configured to create contracts between each of the cell leaders and a plurality of cell members.

6. The system of claim 1, wherein publishing the available manufacturing project comprises:
advertising to entrepreneurs an offer to list the available manufacturing project;
receiving details from the entrepreneur regarding the available manufacturing project; and
electronically posting the details of the available manufacturing project.

7. The system of claim 1, wherein creating the licensing contract comprises:
receiving an offer for contract from project manager; and
forwarding the offer to the entrepreneur.

8. The system of claim 7, wherein creating the licensing contract further comprises accepting electronic signatures documenting a contractual agreement.

9. The system of claim 7, wherein creating the licensing contract further comprises:
providing paperwork documenting terms for the licensing contract; and
recording executed paperwork documenting a contractual agreement.

10. The system of claim 1, wherein creating the contract between the project manager and the cell leader comprises:
receiving an offer for contract from cell leader; and
forwarding the offer to the project manager.

11. The system of claim 10, wherein creating the contract between the project manager and the cell leader further comprises accepting electronic signatures documenting a contractual agreement.

12. The system of claim 1, wherein creating the contract between the cell leader and the cell member comprises:
receiving an offer for contract from cell member; and
forwarding the offer to the cell leader.

13. The system of claim 12, wherein creating the contract between the cell leader and the cell member further comprises accepting electronic signatures documenting a contractual agreement.

14. The system of claim 1, wherein publishing the available manufacturing project comprises:
publishing a product that is available for licensing;
receiving an order for the product from a merchant wishing to sell the product; and
publishing the available manufacturing project based upon the order.

15. The system of claim 1, wherein creating the contract between the cell leader and a cell member to perform the work operation comprises creating an obligation for the cell member to create a product and ship the product to a waypoint.

16. The system of claim 1, wherein creating the contract between the cell leader and a cell member to perform the work operation comprises creating an obligation for the cell member to travel to a certain location to perform designated work.

17. The system of claim 1, wherein the computerized server device further operates programming configured to identify a work operation that does not receive a reasonable bid.

18. The system of claim 1, wherein the computerized server device further operates programming configured to permit the cell leader to reconfigure the work operation.

19. The system of claim 1, wherein the computerized server device further operates programming configured to permit the cell leader to post the work operation to an outside venue seeking fulfillment of the work operation.

20. A computerized system for operating a distributed manufacturing process, comprising:
a computerized server device, operating programming configured to:
publish an available manufacturing project available for license;
create a licensing contract between an entrepreneur owning a licensing right for the available manufacturing project and a project manager seeking the licensing right;
create a plurality of contracts between the project manager and each of a plurality of cell leaders to manage work operation contracts necessary to perform the available manufacturing project;
for each of the cell leaders, create a plurality of contracts between the cell leader and a plurality of cell members to perform a work operation necessary to perform the available manufacturing project; and
provide to each of the project manager, the cell leaders, and the cell members details necessary to perform the available manufacturing project.
